(19) United States
(12) Patent Application Publication
(10) Pub. No.: US 2019/0300714 A1
(43) Pub. Date: Oct. 3, 2019

(54) DUAL EMULSION FOR ASPHALT REJUVENATION

(71) Applicant: Ergon, Inc., Jackson, MS (US)

(72) Inventors: Scott Watson, Richland, MS (US); James Michael Hemsley, JR., Pearl, MS (US); Codrin Daranga, Madison, MS (US); Gaylon Baumgardner, Jackson, MS (US)

(21) Appl. No.: 16/372,565

(22) Filed: Apr. 2, 2019

Related U.S. Application Data
(60) Provisional application No. 62/651,464, filed on Apr. 2, 2018.

(51) Int. Cl. C08L 95/00; E01C 7/18

(52) U.S. Cl. CPC C08L 95/005; E01C 7/187; C08L 2555/84; C08L 2555/64; C08L 2555/74; C08L 2555/34

(57) ABSTRACT

Formulations and methods of making and using two emulsions, one emulsion having a rejuvenating agent and another emulsion having an asphalt phase. The two emulsions may be serially applied or blended together to form a dual emulsion for various deteriorated pavement surface treatments. The two emulsions may be used with a recycled asphalt product, either being mixed with the recycled asphalt product or serially applied to the recycled asphalt product. The two emulsions when blended together may form a dispersion having different phases with different setting times. The surfactant in the rejuvenating emulsion may be faster setting for a preferred initial break and better interaction with the pavement product, while the surfactant in the asphalt emulsion may break more slowly and provide more time to combine with the rejuvenated binder and fully coat the deteriorated asphalt product, and any virgin aggregate added to the mix.

### RELATED APPLICATION

The present application claims the benefit of U.S. Provisional Application No. 62/651,464 filed Apr. 2, 2018 which is hereby incorporated herein in its entirety by reference.

### TECHNICAL FIELD

The present invention generally relates to dual emulsion formulations, and methods of making and using the dual emulsion formulations, including their use with rejuvenating reclaimed asphalt products and also scrub and fog seals.

### BACKGROUND

Asphalt concrete, also known as asphalt pavement, is a composite material that includes mineral aggregate and an asphalt (bitumen) binder which hardens to form a robust surface. Oxidation of asphalt binder during its service life, climate conditions and use of road surfaces, particularly by heavy loads, result in deterioration of asphalt pavement surfaces over time. For example, repeated contraction of the road surface during cold winter nights due to temperature changes results in formation of perpendicular cracks in pavement, known as thermal cracking. The asphalt binder can also become too soft during the hot summer days, resulting in a permanent deformation of the road surface under repeated heavy loads, termed “rutting”. In addition, as a result of continuous mechanical stress, road surfaces become fatigued, resulting in formation of alligator skin-like cracks, known as fatigue fracture. Road surfaces are also known to become brittle due to oxidation processes.

One approach to the progressive deterioration of asphalt pavement involves surface treatment of the existing pavement in an attempt to restore the pavement to its condition when first laid down. For example, U.S. Pat. No. 5,180,428 to Richard D. Koleas discloses a composition including asphalt, a recycling agent, a polymer and an emulsifying agent in an aqueous solution that when deposited upon aged and cracked asphalt pavement rejuvenates the pavement by replenishing solvent oils (maltenes) driven off by wear and exposure to the elements. Additionally, PCT Application No. WO2017/011747 A1 to Baumgardner et al. discloses a polymer-modified emulsion used for rejuvenating or repairing deteriorated asphalt pavement that includes an asphalt phase containing an asphalt and a biobased rejuvenating agent, and an aqueous phase including water and an emulsifying agent, and one or more polymers in the asphalt phase, the aqueous phase or both.

Another approach is to remove and reuse deteriorated pavement after specialized processing. Recycled reclaimed asphalt pavement (RAP) is asphalt pavement that has been removed from a surface, mixed with additives and reapplied to a surface. Asphalt emulsions with a rejuvenator having been added to the asphalt prior to emulsification to assist with rejuvenating the aged asphalt binder in the RAP for Cold-In-Place Recycling (CIR) and Full Depth Reclamation (FDR) applications, including Cold Central Plant (CCP) processes. CCP-produced recycled RAP has been used for various purposes, including shoulder widening, pothole patching and as a base material.

CCP-produced recycled RAP, however, has not been considered appropriate for use on lower volume roads or as a wearing course because it lacks the required structure and density. Reasons for these shortcomings include deficiencies in the asphalt emulsions used in the recycling process, improper manufacturing techniques, stockpile management and application, and deficiencies in the design process. CCP-produced recycled RAP has often been stored in outdoor stockpiles after processing and then used as needed. However, CCP-produced recycled RAP has rarely been stockpiled for longer than 3 months without the addition of fuel oils that may be harmful to the environment, because it does not remain “lively,” that is, with a high content of uncured, unbroken asphalt.

RAP has also been recycled using asphalt emulsions or “cutbacks” that contain volatile solvents, such as diesel fuel or kerosene, which have been considered necessary to rejuvenate the latent oxidized asphalt in the RAP and to extend stockpile life. However, the solvents may be harmful to the environment and to workers involved in their production and use. Further, use of volatile solvents may create added costs that limit the cost-effectiveness of the RAP recycling process.

Accordingly, there is a need for cost-effective recycled reclaimed asphalt pavement formulations, and methods of making and using recycled reclaimed asphalt pavement formulations, whereby the recycled reclaimed asphalt pavement has similar characteristic properties as compared to virgin asphalt pavement, such as tensile strength ratio (TSR), stability, flow/workability and raveling characteristics.

The information included in this Background section of the specification is included for technical reference purposes only and is not to be regarded as subject matter by which the scope of the description is to be bound or as an admission of prior art.

### SUMMARY

Rather than removing deteriorated pavement and replacing with virgin asphalt, it is preferable to recycle and reclaim the deteriorated asphalt into a high-quality pavement product. In other instances, it is preferable to apply a rejuvenator, scrub seal, fog seal, sand seal or chip seal, to rejuvenate and seal the pavement surface.

Under traditional techniques for incorporating rejuvenating products into an asphalt emulsion, the rejuvenating oils are put into the asphalt and then that blend of asphalt and rejuvenator is emulsified. However, this kind of emulsion may exhibit detrimental effects due to the presence of the rejuvenator in the emulsion. Some of the resulting detrimental effects include tender mixes, rutting, low early strength numbers and other similar issues. It is believed that these issues are the result of the rejuvenating agent having to migrate from the asphalt emulsion to the aggregate/RAP particle, which is slowed due to the rejuvenator having an affinity for the asphalt. While these issues resolve themselves over time, the damage is usually done early in the life of the recycled pavement when it is the most vulnerable or tender.

Disclosed is a dual emulsion formulation that includes a rejuvenating emulsion comprising a stable liquid dispersion in water of at least one rejuvenating agent and a first surfactant, and an asphalt emulsion comprising a stable liquid dispersion in water containing an asphalt portion and a second surfactant. The rejuvenating emulsion and asphalt emulsion may be mixed with one another to form a blend. When blended the rejuvenating emulsion and the asphalt emulsion form an aqueous dispersion containing two or more non-aqueous phases each having a different setting time. In certain other aspects, the first surfactant and the second surfactant are the same surfactant provided in different amounts to control the different setting time.

In certain aspects, the dual emulsion may enable an asphalt pavement surface treatment or an interlayer treatment in conjunction with other treatments. These treatments may be used for example, as a rejuvenator, scrub seal, fog seal, sand seal, chip seal, tack coat, bond coat, crack filler or as a material for prevention of reflective cracking. The treatments enable use of a wide variety of asphalts for restoring and rejuvenating deteriorated road pavement.

Also disclosed is a recycled reclaimed asphalt pavement formulation having the two separate rejuvenating and asphalt emulsions to more effectively rejuvenate a reclaimed asphalt, such as in CIR and FDR applications. In some aspects, the overall addition of asphalt content to the pavement mixture may be lowered due to the reclaimed asphalt binder being more effectively rejuvenated by the two emulsions, such that the reclaimed asphalt binder will have improved capability of acting as a binder for the recycled reclaimed asphalt pavement.

In one aspect of the present invention, a method for rejuvenating deteriorated asphalt comprises providing two emulsions, a rejuvenating emulsion comprising a stable liquid dispersion in water of at least one rejuvenating agent and a first surfactant, and an asphalt emulsion comprising a stable liquid dispersion in water containing an asphalt portion and a second surfactant. The emulsions may be provided as separate emulsions that may be mixed to form a blend, or may be employed separately.

In some aspects, the separate emulsions may be mixed simultaneously or in either order with a fractionated recycled asphalt product. In some aspects, the fractionated recycled asphalt product comprises RAP. In other aspects, the fractionated recycled asphalt product may comprise other fractionated asphalt-containing recycled materials such as Recycled Asphalt Shingles (RAS), mixtures of RAP and RAS, and other materials that will be familiar to persons having ordinary skill in the art.

When ordered mixing of such separate emulsions is employed with the fractionated recycled asphalt product, the rejuvenating emulsion preferably is mixed with the fractionated asphalt product first, followed by mixing with the asphalt emulsion. The rejuvenating emulsion and asphalt emulsion may also be mixed with one another to form a blend, which then may be mixed with the fractionated asphalt product. When a blend is employed, the rejuvenating emulsion preferably is formulated to break earlier than the asphalt emulsion. The resulting mixture of the separate emulsions or blend of emulsions with the fractionated recycled asphalt product can be applied to a surface as a mixture of the rejuvenating emulsion, the asphalt emulsion, and the fractionated recycled asphalt product. In certain aspects, virgin stone can be added to modify gradation.

In certain aspects of the present invention, two separate emulsions are provided to rejuvenate deteriorated asphalt and make recycled reclaimed asphalt pavement. The first emulsion has a stable liquid dispersion in water of at least one rejuvenating agent and a first surfactant with no additional virgin asphalt added, and the second emulsion has a stable liquid dispersion in water containing an asphalt portion and a second surfactant. In some aspects, the asphalt portion in the second emulsion is a virgin asphalt. In some aspects, the asphalt portion of the second emulsion is a paving grade emulsion. In some aspects, the second emulsion does not contain a rejuvenating agent.

In some aspects, the existing deteriorated pavement is milled and mixed with the rejuvenating emulsion having at least one rejuvenating agent to provide an intermediate reclaimed mixture, which may be stockpiled or placed into a windrow. The intermediate reclaimed mixture may then be mixed with the asphalt emulsion, which may be paving grade, in a mix-paver type application to provide a recycled reclaimed asphalt pavement. The recycled reclaimed asphalt pavement may then be used in a typical paving application for roadways and the like.

In some aspects, the two separate emulsions are produced and blended together before being applied to a fractionated recycled asphalt product forming a blended emulsion having two separate dispersed phases—one dispersion of the rejuvenating agent and the other dispersion of paving grade asphalt. The proportions of each emulsion can be chosen so that the rejuvenating agent is matched to soften the residual asphalt in the fractionated recycled asphalt product to the desired asphalt grade. The straight asphalt emulsion can be added to complete the desired overall binder content in the recycled reclaimed asphalt pavement mix. In some aspects, the surfactant in the production of the rejuvenating emulsion can be chosen to have a faster setting for a preferred initial break and better interaction with the fractionated recycled asphalt product. The second asphalt emulsion can have a surfactant with a longer setting to break more slowly and provide more mixing time to combine with the rejuvenated binder and fully coat the reclaimed pavement, and in some aspects any virgin aggregate that may be added to the mix.

The above summary is not intended to describe each illustrated embodiment or every implementation of the subject matter hereof. The figures and the detailed description that follow more particularly exemplify various embodiments.

### DETAILED DESCRIPTION

The term “about” refers to a range of numbers that is considered equivalent to the recited value (e.g., having the same function or result). In many instances, the term “about” may include numbers that are rounded to the nearest significant figure.

The term “biobased” refers to compositions from natural or biological resources, including derivatives or modifications thereof.

The term “polymer” includes, independently, homopolymers, copolymers, terpolymers, block copolymers, segmented copolymers, graft copolymers, and any mixture or combination thereof.

The term “deteriorated” refers to cracked, aged, oxidized or distressed asphalt pavement, for example distressed asphalt pavement like that identified by Miller, John S., and William Y. Bellinger, Distress identification manual for the long-term pavement performance program, publication No. FHWA-HRT-13-092 (2014).

The term “emulsifying agents” refer to surfactants (including biodegradable surfactants) and to stabilizing agents. Emulsifying agents maintain an asphalt material in a stable particulate suspension in an aqueous emulsion and control the emulsion breaking time, where the breaking time is the time required for the emulsified asphalt materials to separate from the aqueous phase permitting water evaporation and formation of a cured or set coating.

The term “meth” in parentheses, such as “(meth)acrylate,” refers either to an acrylate or to a methacrylate, or mixtures of both. Similarly, the term (meth)acrylamide refers either to an acrylamide or to a methacrylamide, or mixtures of both.

Numerical ranges expressed using endpoints include all numbers subsumed within that range (e.g. 1 to 5 includes 1, 1.5, 2, 2.75, 3, 3.80, 4 and 5).

All percentages are weight percentages.

A dual emulsion formulation of the present invention includes a rejuvenating emulsion and an asphalt emulsion. The rejuvenating emulsion comprises a stable liquid dispersion in water of at least one rejuvenating agent and a surfactant. The asphalt emulsion comprises a stable liquid dispersion in water containing an asphalt portion and a surfactant. The rejuvenating emulsion and asphalt emulsion may be mixed with one another to form a blend. When blended the rejuvenating emulsion and the asphalt emulsion form an aqueous dispersion containing two or more non-aqueous phases each having a different setting time. In some aspects, the surfactant in the rejuvenating emulsion and the asphalt emulsion are the same, such that they could have the same setting time. In some other aspects, the amount of the surfactant in the rejuvenating emulsion and the asphalt emulsion are adjusted to have the desired setting time.

The dual emulsion may enable an asphalt pavement surface treatment or an interlayer treatment in conjunction with other treatments. These treatments may be used for example, as a rejuvenator, scrub seal, fog seal, sand seal, chip seal, tack coat, bond coat, crack filler or as a material for prevention of reflective cracking. The treatments enable use of a wide variety of asphalts for restoring and rejuvenating deteriorated road pavement.

The dual emulsion of the present invention may also be used in a recycled reclaimed asphalt pavement formulation to more effectively rejuvenate a reclaimed asphalt in CIR and FDR applications. In some aspects, the overall addition of asphalt content to the pavement mixture may be lowered due to the reclaimed asphalt binder being more effectively rejuvenated by the dual emulsion, such that the reclaimed asphalt binder will have improved capability of acting as a binder for the recycled reclaimed asphalt pavement. In some aspects, a portion of virgin asphalt binder is combined with the rejuvenated asphalt to form a finished layer with higher retained TSR (lower dry TSR, but similar wet TSR), higher retained Marshall Stability, and lower mass loss in a Raveling Test, as compared to current finished layer production using virgin asphalt and the same or similar asphalt emulsion without the presence of the rejuvenating emulsion.

The disclosed rejuvenating emulsions may contain a variety of rejuvenating agents (sometimes called recycling agents). Petroleum based rejuvenating agents can comprise an aromatic rejuvenating oil, a naphthenic rejuvenating oil, a paraffinic oil, or a mixture thereof. Petroleum based rejuvenating agents, such as for example, RECLAMITE™ RA-1 from Tricor Refining, LLC can be used to replenish maltenes in asphalt pavement. However, such petroleum based rejuvenating agents are not renewable resources. In accordance with this disclosure, a biobased rejuvenating agent may be used instead of a petroleum based rejuvenating agent or may be used in combination with a petroleum based rejuvenating agent.

Biobased rejuvenating agents may include oils or esters from natural or biological resources, including derivatives or modifications thereof. Without being bound by theory, it is believed that the biobased rejuvenating agent may function as a softening agent for the bitumen in asphalt pavement. Non-limiting examples of biobased rejuvenating agents include one or more of a vegetable oil or ester thereof, a seed oil or ester thereof, a soybean oil or ester thereof, a corn oil or ester thereof, a palm oil or ester thereof, a canola oil or ester thereof, a safflower oil or ester thereof, a sunflower oil or ester thereof, a citrus oil or ester thereof, pine oil or ester thereof, a rosin oil or ester thereof, a tall oil or derivative thereof, or a biobased fatty acid ester.

Exemplary commercially available rejuvenating agents include those available from Cargill Incorporated under the AGRI-PURE GOLD™ brand (such as AGRI-PURE GOLD53, 55, 63S, 67, 135, 142S, 200, 500, 750S, and 2000) and the ANOVA™ brand asphalt rejuvenators, those available from Arizona Chemical, LLC under the SYLVAROAD™ brand, and those available from the Archer Daniels Midland Company. In certain embodiments, seed oils may be preferred rejuvenating agents. In other embodiments, tree based oils such as pine oil or rosin oil may be preferred.

In some aspects, the rejuvenating emulsion preferably employs a rejuvenating agent in amounts suitable to permit the penetration of the rejuvenating agent into the surface of the aged and deteriorated asphalt aggregate. For example, a petroleum based rejuvenating agent, biobased oil or ester thereof, or combinations thereof, may restore some of the original properties to the asphalt. The amount of the rejuvenating agent in the emulsion can be adjusted depending on the pavement condition of the fractionated recycled asphalt product which the rejuvenating emulsion will be mixed. The amount of rejuvenating agent can be increased to ensure adequate dosing for deteriorated asphalt concrete to restore the maltene fraction of the deteriorated asphalt.

The amount of the rejuvenating agent may for example be about 50%, preferably about 25% to about 75%, preferably about 30% to about 70%, or preferably about 40% to about 60% by total weight of the rejuvenating emulsion. The weight ratio of the rejuvenating agent to water in the rejuvenating emulsion may for example be from about 0.25:1 to about 3:1, from about 0.5:1 to about 1.5:1, from about 1:3 to about 3:1, from about 1:2 to about 2:1, or about 1:1. The amount of rejuvenating agent may also be such that an asphalt's viscosity is restored for example to about 1,000 to about 3,000 poise at 60° C. Those of ordinary skill in the art are capable of selecting a specific rejuvenating agent and the specific amount of the rejuvenating agent in the emulsion to achieve the desired restoration of asphalt in the fractionated recycled asphalt product.

The rejuvenating agent phase of the rejuvenating emulsion may for example represent from about 30% to about 70% of the total rejuvenating emulsion weight. The corresponding aqueous phase of the rejuvenating emulsion may for example represent from about 70% to about 30% of the total rejuvenating emulsion weight.

There are typically four categories of emulsifying agents, namely cationic, anionic, amphoteric and nonionic. Depending on the type of emulsifying agent used, an acid or a base may be needed to activate the emulsifying agent.

For example, when cationic emulsifying agents are used, acid may be added to adjust the emulsion pH to between 1.0 and 7.0. Suitable acids include inorganic acids, for example hydrochloric acid and phosphoric acid. The acid promotes a positive charge on the emulsifying agent. A subcategory of cationic emulsifying agents, known as quaternary ammonium salts, do not require acid activation because the charge is built into the emulsifying agent.

When anionic emulsifying agents are used, base may be added to adjust the emulsion pH to between 7.0 and 12.0. Suitable bases include inorganic bases, for example sodium hydroxide and potassium hydroxide. The base promotes a negative charge on the emulsifying agent.

When amphoteric emulsifying agents are used both the cationic and anionic chemical functionality are built into the same molecule. Therefore, either functionality may be activated, the cationic portion may be activated by acid, or the anionic portion may be activated by base.

When nonionic emulsifying agents are used, it may not be necessary to activate the emulsifying agent with either acid or base.

The amount of emulsifying agent should preferably be sufficient to maintain a stable emulsion. The concentration can vary based on the type of emulsifying agents used and other components of the emulsion but is generally from greater than 0 to about 5% by weight of the emulsion, for example from about 0.01% to about 3.0% by weight of the emulsion.

Exemplary cationic emulsifying agents include polyamines, fatty amines, fatty amido-amines, ethoxylated amines, propoxylated amines, diamines, imidazolines, quaternary ammonium salts, and mixtures thereof. Commercial cationic emulsifying agents include, for example, those available from Akzo Nobel Surface Chemistry under the REDICOTE™ brand (including REDICOTE E-4819, REDICOTE E-64 R E, REDICOTE E16, REDICOTE E-9, REDICOTE EM-44, REDICOTE C-346, REDICOTE E-7000 and REDICOTE E-70), those from ArrMaz under the ARRTEKK™ brand (including ARRTEKK 710 and ARRTEKK 720), and from MeadWestvaco Corporation under the INDULIN™ brand (including INDULIN F-80, INDULIN DF-60, INDULIN DF-40, INDULIN DF-42, INDULIN DF-30, INDULIN R-20, INDULIN AA 54, INDULIN AA 56, INDULIN AA 57, INDULIN AA-71, INDULIN AA-78, INDULIN AA-83, INDULINAA-86, INDULIN AA-89 and INDULIN UFC).

Exemplary anionic emulsifying agents include alkali metal or ammonium salts of fatty acids, alkali metal polyalkoxycarboxylates, alkali metal N-acylsarcosinates, alkali metal hydrocarbylsulphonates, for example, sodium alkylsulphonates, sodium arylsulphonates, sodium alkylarylsulphonates, sodium alkylarenesulphonates, sodium lignosulphonates, sodium dialkylsulphosuccinates and sodium alkyl sulphates, long chain carboxylic and sulphonic acids, their salts and mixtures thereof.

Exemplary amphoteric emulsifying agents include betaines and amphoteric imidazolinium derivatives.

Exemplary non-ionic emulsifying agents include ethoxylated compounds and esters, for example ethoxylated fatty alcohols, ethoxylated fatty acids, sorbitan esters, ethoxylated sorbitan esters, ethoxylated alkylphenols, ethoxylated fatty amides, glycerine fatty acid esters, alcohols, alkyl phenols, and mixtures thereof.

The emulsifying agents or other additives may represent from about 0.01% to about 3.0% of the total rejuvenating emulsion weight, and preferably from about 0.5% to about 3.0% of the total rejuvenating emulsion weight.

The emulsifying agents or other additives may represent from about 0.01% to about 3.0% of the total asphalt emulsion weight, and preferably from about 0.5% to about 3.0% of the total asphalt emulsion weight.

The disclosed asphalt emulsions may employ various asphalt grades depending on the expected pavement temperatures. The asphalt composition grades used in the emulsion may be defined by the Performance Grade (PG) values of the Strategic Highway Research Program (SHRP) or the American Association of State Highway and Transportation Officials (AASHTO) M320 standards. The asphalt composition grades may for example include about PG-94 (about 5-10 pen) to about PG-52 (about 160-220 pen), about PG-88 (about 10-20 pen) to about PG-64 (about 50-70 pen), or about PG-64 (about 50-70 pen) to about PG-52 (about 160-220 pen).

The asphalts used may be, for example, oxidized or air-blown asphalts, non-oxidized asphalts and blends thereof. In other aspects, the asphalt includes, but is not limited to, asphalt produced from atmospheric distillation, vacuum distillation, solvent extraction, air, or combinations of these methods. Still other asphalts may include naturally occurring asphalts such as gilsonite, asphaltites, and the like.

Asphalt blowing, also referred to as oxidation or air rectification, may be used to produce oxidized or air blown asphalt of desired consistency from a softer asphalt than the final asphalt product yielded by the blowing process. The desired result of the blowing process is an increase in softening point and a reduction in penetration values over that of the starting, base asphalt. Typically, the blowing process includes heating the base asphalt, generally to a temperature of 232.2° C. (450° F.) to 260° C. (500° F.), and blowing air into the hot asphalt for a period of time required to yield the desired properties. The blowing process is a temperature-time dependent process with an inverse relationship of temperature and time. Thus, at higher temperatures the blowing time is generally less than the time required to achieve the same properties at lower temperature. The exchange surface or contact surface between the hot asphalt and the air forced into it generally also is a factor in determining the blowing process length and the required air quantity.

Maltenes are the non-asphaltene fraction of asphalt, referred to as deasphalted or deasphaltened oil. The maltene fraction of asphalt includes polar resins, and aromatic and saturated solvents. A deteriorated asphalt may exhibit a low level of maltenes.

The asphalt phase of the asphalt emulsion may for example represent from about 40% to about 80% of the total asphalt emulsion weight. The corresponding aqueous phase of the asphalt emulsion may for example represent from about 80% to about 40% of the total asphalt emulsion weight.

Many of the same emulsifying agents may be used in the asphalt emulsion as previously discussed above. Although often times the emulsifying agent of the asphalt emulsion will be different than the emulsifying agent in the rejuvenating emulsion, such that the emulsifying agents have different setting times. In some aspects, the emulsifying agent or surfactant in the production of the rejuvenating emulsion can be chosen to have a faster setting for a preferred initial break. The second asphalt emulsion can have an emulsifying agent or surfactant with a longer setting to break secondarily.

The disclosed two-part emulsion system may be blended with fractionated recycled asphalt product, such as RAP, RAS, or mixtures thereof, to produce a mix that has good coating by good workability of the rejuvenated binder and the virgin binder. For example, the rejuvenating emulsion may be provided in an amount of about 0.5% by weight of the fractionated recycled asphalt product while the asphalt emulsion may be provided in an amount of about 2.5% by weight of the fractionated recycled asphalt product. Since the combination of the rejuvenating emulsion and asphalt emulsion by weight of the fractionated recycled asphalt product tends to outperform a virgin asphalt emulsion at the same percentage by weight of the fractionated recycled asphalt product, a reduction in the total two-part emulsion content can occur, thus reducing the overall cost of the application. Additionally, the amount of one emulsion may be increased within certain limits if the concentration of another emulsion is correspondingly decreased, without significantly altering the properties of the resulting recycled reclaimed asphalt pavement. For example, the rejuvenating emulsion may be provided in a range of about 0.25% to about 4.75% by weight of the fractionated recycled asphalt product while the asphalt emulsion may be provided in a range of about 4.75% down to about 0.25% by weight of the fractionated recycled asphalt product.

In some aspects, the mixture of the rejuvenating emulsion and the asphalt emulsion comprises less than about 7% by weight of the fractionated recycled asphalt product, in some aspects less than about 6%, in some aspects less than about 5%, in some other aspects less than about 4%, in some other aspects less than about 3%, in some other aspects less than about 2.5%, in some other aspects less than about 2.25%, in some other aspects less than about 2%, in some other aspects less than about 1.5%, and in some other aspects less than about 1.0%, by weight of the fractionated recycled asphalt product.

In some aspects, the rejuvenating emulsion contains no additional asphalt, such that the only asphalt source is from the expired asphalt in the recycled pavement and any asphalt in the asphalt emulsion. The disclosed asphalt emulsion desirably includes substantial asphalt content. For example, the asphalt concentration may be about 40% to about 80% of the total weight of the asphalt emulsion. In some aspects, the asphalt emulsion contains the asphalt portion and water in a weight ratio of about 1:1 to about 3:1.

In some aspects, deteriorated pavement may be removed by milling or full-depth removal. Upon removal, the deteriorated pavement may undergo processing, such as fractionating and screening into a desired size. When properly fractionated and screened, fractionated recycled asphalt product consists of high-quality, well-graded aggregates coated by existing (viz., aged or used) asphalt cement.

In some aspects of the present invention, the fractionated recycled asphalt product passes through a 1¼ inch sieve (viz., has a size less than about 1¼ inch), in some aspects has a size less than about 1 inch, in some aspects has a size less than about ¾ inch, in some aspects has a size less than about ½ inch, and in some aspects has a size less than about ⅜ inch. In some aspects, 100% of the fractionated recycled asphalt product passes through a 1¼ inch sieve and in some other aspects through a 1 inch sieve. In some aspects, at least about 95% of the fractionated recycled asphalt product has a size less than about ¾ inch, in some aspects at least about 70% of the fractionated recycled asphalt product has a size less than about ½ inch, and in some aspects at least about 60% of the fractionated recycled asphalt product has a size less than about ⅜ inch.

When the disclosed dual emulsion is mixed with fractionated recycled asphalt product, the rejuvenating emulsion may have at least one rejuvenating agent and a surfactant having a first setting, and the asphalt emulsion may have an asphalt phase and a surfactant having a second setting to break more slowly than the first setting.

The rejuvenating emulsion, the asphalt emulsion, or both, may for example contain a cationic, anionic, amphoteric or non-ionic surfactant, and may lend an ionic or neutral character to the final blend depending upon the desired emulsion's electrochemical properties or the intended emulsion use, for example, the surface type on which the emulsion is to be applied.

In some aspects, the mixture of the rejuvenating emulsion and the asphalt emulsion comprises up to about 5% by weight of the fractionated recycled asphalt product. In other aspects, the mixture of the rejuvenating emulsion and the asphalt emulsion comprises up to about 4% by weight of the fractionated recycled asphalt product. In still some other aspects, the mixture of the rejuvenating emulsion and the asphalt emulsion comprises up to about 3% by weight of the fractionated recycled asphalt product.

In some aspects, the rejuvenating emulsion comprises up to about 2% by weight of the fractionated recycled asphalt product, while in some other aspects the rejuvenating emulsion comprises up to about 1% by weight of the fractionated recycled asphalt product, and in still other aspects, the rejuvenating emulsion comprises up to about 0.5% by weight of the fractionated recycled asphalt product.

In some aspects of the present invention, the asphalt emulsion, rejuvenating emulsion, or both, may include one or more polymers in the asphalt phase, the aqueous phase or both. Exemplary polymers include those that assist in providing desired properties for the asphalt emulsion residue, for example by, providing a stress-absorbing layer that strongly adheres to the underlying pavement, by providing a non-tacky surface, or by providing a polymer with a non-swelling nature. The polymers may for example be about 1%, 2% or 3% to about 15%, 10% or 6% by total weight of the total emulsion. The selection of a specific polymer or polymers for a rejuvenating application may depend upon many variables such as, for example, the type of pavement, pavement conditions, weather cycles, seasonal weather conditions, traffic volumes, etc. Those of ordinary skill in the art will with the assistance of this disclosure be capable of selecting an appropriate polymer or polymers to assist in the desired rejuvenation of a particular pavement. Additionally, those of ordinary skill in the art will recognize that the combination of polymers in one or both phases of the emulsion may provide particular advantages in rejuvenating asphalt in the fractionated recycled asphalt product or provide increased strength and/or flexibility to the overall pavement structure.

In some aspects, one or more polymers may be added to either an asphalt phase, the aqueous phase, or both phases of the asphalt emulsion. In some aspects, one or more polymers may be added to the aqueous phase of the rejuvenating emulsion.

In some embodiments, the asphalt phase incorporates one or more polymers as a modifier to enhance specific physical characteristics of the resulting residue. Exemplary polymers include those that assist in providing desired properties for the asphalt emulsion residue. The polymers may for example be about 4% to 8% by weight of the asphalt phase or about 1% to about 15% by total weight of the asphalt emulsion.

Various embodiments of the asphalt emulsion of this disclosure may include any elastomer or plastomer. Non-limiting examples of such polymers include styrene-butadiene rubber, styrene-butadiene-styrene rubber, polychloroprene, styrene butadiene plastomers, polyurethanes, thermoplastic olefins (for example, oxidized polyethylene wax or ethylene terpolymer), thermoplastic polyamides, or acrylate terpolymers (for example, glycidyl methacrylate).

In other embodiments, the one or more polymers may be utilized in the emulsion as a dispersion and added to the aqueous phase of the asphalt emulsion or to the rejuvenating emulsion. Exemplary lattices of styrene butadiene rubber, styrene-butadiene-styrene and polychloroprene as well as others may be incorporated into the aqueous phase of the asphalt emulsion or rejuvenating emulsion.

In some embodiments, acrylic polymers may be well suited for use in one or both of the emulsions. Acrylic polymers are often supplied as a dispersion and therefore may be included in the aqueous phase of one or both of the emulsions. The acrylic polymer or copolymers are preferably derived from acrylate monomers. The acrylate monomers may for example be based on (meth)acrylic acid, esters of (meth)acrylic acid, (meth)acrylamide, (meth)acrylonitrile and derivatives of these acrylate monomers. Exemplary esters of (meth)acrylic acids include, but are not limited to, alkyl and hydroxyalkyl esters, e.g., methyl (meth)acrylates, ethyl (meth)acrylates, butyl (meth)acrylates, hydroxyethyl (meth)acrylate, isobornyl (meth)acrylate, and longer chain alkyl (meth)acrylates such as ethylhexyl (meth)acrylate, lauryl (meth)acrylate, cetyl (meth)acrylate, and stearyl (meth)acrylate. Derivatives of (meth)acrylamide include, but are not limited to, alkyl substituted (meth)acrylamides, e.g., N,N-dimethyl (meth)acrylamide, N,N-dipropyl (meth)acrylamide, t-butyl (meth)acrylamide, N-octyl (meth)acrylamide, and longer chain alkyl (meth)acrylamides such as N-lauryl (meth)acrylamide and N-stearyl (meth)acrylamide. The acrylic polymers also include polymers commonly known as acrylics, acrylate polymers, polyacrylates or acrylic elastomers. Acrylate polymers belong to a group of polymers which could be referred to generally as plastics while acrylic elastomer is a general term for a type of synthetic rubber whose main component is an acrylic acid alkyl ester (for example, an ethyl or butyl ester).

Exemplary copolymers include polymers derived from polyolefins such as vinyl acetate, vinyl chloride, vinylidene chloride, styrene, substituted styrene, butadiene, unsaturated polyesters, ethylene and the like. In some embodiments, the acrylic copolymer is derived from acrylate monomers and mixtures thereof and polymerized with styrene or ethylene. In still other embodiments, the acrylic copolymer is derived from butyl acrylate and copolymerized with styrene or ethylene. In yet other embodiments, the copolymer may be an acrylonitrile butadiene copolymer.

Exemplary acrylic polymers or copolymers include those available from the BASF Corporation under the ACRONAL™ brand (such as ACRONAL NX 4627 and ACRONAL NX 4627 X) and those available from Bayer MaterialScience AG under the BAYHYDROL™ brand. Other exemplary acrylic polymers or copolymers are available from Michelman under the LICOMER™ brand, from Wacker under the VINNAPAS™ brand, from Synothomer under the REVACRYL™ brand, from Arkema under the ENCOR™ brand, and from Westlake under the EBAC™ brand.

With certain applications, it may be desirable to incorporate one or more polymers in each of the asphalt phase and the aqueous phase of the asphalt emulsion. The incorporation of polymers in this manner may permit selective combinations to achieve desired physical characteristics. Alternatively, it may be desirable in certain embodiments to incorporate different polymers into a single phase of the asphalt emulsion. Still further, it may be desirable in certain embodiments to incorporate different polymers in one phase of the asphalt emulsion and the water phase of the rejuvenating emulsion.

The emulsion may contain other additives to adjust the emulsion properties in relation to the planned use, application method, and storage conditions. These include, for example, mineral salts, thickening agents, stabilizing agents, anti-freeze agents, adhesion promoters, biocides, pigments and the like.

Exemplary stabilizing agents may include polysaccharides, e.g., biodegradable glucopyranose, glycans such as β-D glucans, scleroglycans (CAS No. 39464-87-4), schizophyllan (CAS No. 9050-67-3), laminaran (CAS No. 9008-22-4), cinerean, lentinan (CAS No. 37339-90-5), curdlan (CAS No. 54724-00-4) glucose polymers, preservatives, and the like. Other stabilizing agents may include cellulose compounds or derivatives thereof, e.g. microcrystalline cellulose (AVICEL™ RC591), ethylcellulose and gunge (NATRASOL™).

Exemplary thickening agents include scleroglucan, scleroglucan modified with glyoxal or with another reactant, guar gum, gum arabic, ghatti gum, karaya gum, gum tragacanth, locust bean gum, xanthan gum, and water-soluble polyurethanes resulting in particular from the reaction of one or more polyisocyanates with one or more polyols chosen from polyester polyols and polyether polyols.

Other exemplary thickening agents are available from Latexfalt, b.v. Koudekerd a/d Rijn, The Netherlands and as described in WO 2009/113854 A1.

The specific weight percentages of the rejuvenating agent in the rejuvenating emulsion and the asphalt phase and the aqueous phase in the final asphalt emulsion may be chosen depending on factors such as the preexisting pavement composition or the base course materials and conditions, or the number of planned applications, the desired cure time, and user agency regulations or specifications. Similarly, the emulsifying agents, stabilizing agents, and other additives may be adjusted for specific application conditions, asphaltic materials, and substrates.

The final combined emulsions are preferably formulated such that, after application, the rejuvenating agent in the rejuvenating emulsion rejuvenates the deteriorated asphalt by restoring all or part of its resinous component, including the maltene or other aromatic content.

The two emulsions may each be prepared in advance of their application or at a work site immediately before their application. If desired, the emulsions may be prepared as concentrates that may later be mixed with sufficient water to produce the desired final emulsion on a continuous basis during application using metering and mixing equipment known to those skilled in the art.

The emulsions may generally be formulated to achieve a desired residue upon breaking of the respective emulsion and drying or removal of the aqueous portion of each emulsion. The procedures for recovering the residue are set forth in the Examples section of this disclosure. In certain embodiments, residue recovery may generally range from about 30% to about 70% by weight of the emulsion.

Complex modulus may be a characteristic useful for demonstrating the effectiveness of the emulsion. In certain applications, the complex modulus can be an indication of the stiffness or strength of the residue of the emulsion. Complex modulus is determined using a dynamic shear rheometer, often over an extended period of time, to determine the characteristics of the residue under controlled stress and strain. The procedure for determining the complex modulus is set forth in the Examples section of this disclosure. The specific grade of asphalt and the type and amount of polymer employed in the emulsion may impact the reported complex modulus.

In certain aspects, the dual rejuvenating and asphalt emulsion may be utilized in FDR and CIR applications, whereby the dual emulsion may be blended, mixed simultaneously, or mixed in either order, with RAP and in some aspects other aggregates, including aggregate base, subgrade base, granular base, or mixtures thereof.

In some aspects for FDR applications, when the dual emulsion is mixed with RAP, the RAP may represent less than 85 wt. % of the total mixture, with other aggregate material, such as aggregate base, subgrade base, granular base, or mixtures thereof, representing the remaining amount of the mixture. In some aspects, the RAP has a sieve size of 2 inches with 100 minimum percent passing and a sieve size of ¾ inch with 85 minimum percent passing. In some other aspects, the RAP has a sieve size of 1¾ inches with 100 minimum percent passing and a sieve size of ¾ inch with 85 minimum percent passing.

In some aspects for CIR applications, the dual emulsion is mixed with RAP, the RAP represents greater than 85 wt. % of the total mixture. In some aspects, the RAP represents less than about 15 wt. % of granular base, based upon the total weight of the mixture.

The disclosed composition is further illustrated in the following non-limiting examples. Various modifications and alterations of the disclosed compositions will be apparent to those skilled in the art without departing from the scope of this disclosure.

### EXAMPLES

Testing was conducted by combining a rejuvenating emulsion with an asphalt emulsion typically used for FDR and CIR applications with fractionated recycled asphalt product. The contents of the rejuvenating emulsion and the typically used asphalt emulsion are provided in Table 1.

TABLE 1
Emulsion Contents

| | Rejuvenating Emulsion | Asphalt Emulsion |
|---|---|---|
| Component | (approx. % in blend) | (approx. % in blend) |
| Asphalt | — | 62 |
| (PG64-22) | | |
| Rejuvenating agent | 52 | — |
| (RSE-1114) | | |
| Water | 48 | 36.5 |
| Surfactant | trace | — |
| (INDULIN AA-86) | | |
| Surfactant | — | 1.5 |
| (PC 2024) | | |

Recycled asphalt production (RAP-2) was used as the aggregate/fractionated recycled asphalt product blend for testing. The fractionated recycled asphalt product had the size gradation provided in Table 2, although one of ordinary skill in the art will appreciate that other gradations are contemplated.

TABLE 2
FRACTIONATED RECYCLED ASPHALT PRODUCT Gradation

| | |
|---|---|
| Sieve Size | % Passing |

| | | |
|---|---|---|
| 1 | inch | 100 |
| ¾ | inch | 93 |
| ½ | inch | 67 |
| ⅜ | inch | 53 |

| | |
|---|---|
| No. 4 | 30 |
| No. 8 | 23 |
| Pan | 0.0 |

The rejuvenating emulsion and the asphalt emulsion were applied to the fractionated recycled asphalt product aggregate in two different blends. The first blend, denoted as Blend(A), employed 0.5% of the rejuvenating emulsion mixed with the fractionated recycled asphalt product aggregate (allowing the rejuvenating emulsion to coat the fractionated recycled asphalt product aggregate), followed by addition of 2.5% (based on the weight of fractionated asphalt product aggregate) of the asphalt emulsion. This provided aJob Mix Formula (JMF) of 3.0% total emulsion. The second blend, denoted as Blend(B), employed the rejuvenating emulsion and the asphalt emulsion blended together prior to mixing with the fractionated recycled asphalt product aggregate. In Blend(B), a ratio of 1:5 of the rejuvenating emulsion to the asphalt emulsion was used to keep the emulsion relationship consistent with Blend(A), and sufficient Blend(B) was employed to provide a total blended emulsion content of 3.0% by weight of fractionated recycled asphalt product aggregate. As such, the total amount of emulsion used by weight of the fractionated recycled asphalt product aggregate was 3.0% for both Blend(A) and Blend(B). The mix characteristic properties for Blend(A) and Blend(B) were analyzed and compared to a typical optimized asphalt emulsion (asphalt emulsion alone in Table 2 above) at 3.0% by weight of the fractionated recycled asphalt product aggregate, and are summarized in Table 3.

TABLE 3
Property Characteristics of Blend(A),
Blend(B) and Typical Asphalt Blend.

| Property | Blend(A) | Blend(B) | Optimized Asphalt Blend |
|---|---|---|---|
| Wet Density (pcf) | 136.7 | 137.0 | 120.1 |
| Dry Density (pcf) | 130.8 | 131.4 | 109.0 |
| Bulk Density (G_{MB}) | 2.178 | 2.183 | 1.825 |
| Dry TSR (lb) | 903 | 926 | 1606 |
| Wet TSR (lb) | 691 | 726 | 788 |
| % Retained | 76.5 | 78.5 | 50 |
| Dry Marshall (lb) | 2748 | 2732 | 4218 |
| Wet Marshall (lb) | 2993 | 2637 | 3683 |
| % Retained Marshall | 109 | 97 | 87.3 |

| | Temperature | | Temperature | | Temperature |
|---|---|---|---|---|---|
| | 10 C. | 25 C. | 10 C. | 25 C. | 10 C. |
| Raveling - % Loss | 1.12 | 2.56 | 1.24 | 2.32 | 2.90 |

As provided by the property characteristic in Table 3, Blend(A) and Blend(B) had similar properties, and outperformed application of the typical asphalt emulsion to fractionated recycled asphalt product aggregate alone. Regardless of whether the rejuvenating emulsion was mixed with the fractionated recycled asphalt product aggregate before being blended with the asphalt emulsion, or the rejuvenating emulsion and asphalt emulsion were blended before application to the fractionated recycled asphalt product aggregate, the rejuvenating emulsion provided similar results in TSR, Stability, and Raveling characteristics. When compared to the optimized asphalt blend, use of the disclosed rejuvenating emulsion and asphalt emulsion provided higher retained TSR, higher retained Marshall Stability, and lower mass loss on Raveling.

Pre-blending the rejuvenating emulsion and the asphalt emulsion as in Blend(B) tended to produce a mix that better coated the fractionated recycled asphalt product aggregate than Blend(A) whereby the rejuvenating emulsion was mixed with the fractionated recycled asphalt product aggregate alone before the asphalt emulsion is added. Both Blend(A) and Blend(B) provided good coating and workability making this product useful with one tank and multiple jobs/mixing capabilities.

Since both Blend(A) and Blend(B) outperformed the current optimized emulsion, either Blend(A) or Blend(B) could be used at a reduced total emulsion content level, thereby reducing the overall cost of the application. To be clear, it is noted that the “Optimized Asphalt Blend” in Table 3 utilized the Asphalt Emulsion formulation of Table 1 applied to fractionated recycled asphalt product aggregate in production of the pavement mixture data of Table 3.

Based upon the foregoing data, without wishing to be bound by theory, it is believed that both the emulsion break speed due to the surfactant used with the rejuvenating agent and lessening the extent to which the rejuvenating agent may have to migrate out of the asphalt results in speeding up the diffusion or migration (rejuvenation) of the agent into the fractionated recycled asphalt product asphalt or aggregate particles. The faster that this diffusion or migration happens, the tougher the mix becomes thus reducing detrimental effects to strength or stability in the early life of the recycled or restored pavement. Also, by bringing the rejuvenating agent into early contact with the old asphalt on the fractionated recycled asphalt product, some of the rejuvenated fractionated recycled asphalt product asphalt can be used to reduce the amount of new asphalt needed to obtain desired strengths, density and durability of the newly recycled materials. This can reduce the overall costs associated with using virgin asphalt product in a recycled mix.

In some embodiments, the present invention is directed at a method for rejuvenating deteriorated asphalt, the method comprising mixing a rejuvenating emulsion and an asphalt emulsion to form a rejuvenation formulation, the rejuvenating emulsion comprising a stable liquid dispersion in water of at least one rejuvenating agent and a first surfactant, and the asphalt emulsion comprising a stable liquid dispersion in water containing an asphalt portion and a second surfactant; and applying to a surface the rejuvenation formulation.

In some embodiments, the present invention is directed at a method for rejuvenating deteriorated asphalt, the method comprising providing a rejuvenating emulsion comprising a stable liquid dispersion in water of at least one rejuvenating agent and a first surfactant; providing an asphalt emulsion comprising a stable liquid dispersion in water containing an asphalt portion and a second surfactant; providing a fractionated recycled asphalt product; and applying to a surface a mixture of the rejuvenating emulsion, the asphalt emulsion, and the fractionated recycled asphalt product.

In some embodiments, the present invention is directed at a method of making recycled reclaimed asphalt pavement comprising fractionating a reclaimed asphalt pavement to form a fractionated recycled asphalt product; and combining the fractionated recycled asphalt product, a rejuvenating emulsion comprising a stable liquid dispersion in water of at least one rejuvenating agent and a first surfactant, and an asphalt emulsion comprising an asphalt portion and a second surfactant.

In some embodiments, the present invention is directed at a rejuvenation formulation comprising a rejuvenating emulsion comprising a stable liquid dispersion in water of at least one rejuvenating agent and a first surfactant; and an asphalt emulsion comprising a stable liquid dispersion in water containing an asphalt portion and a second surfactant.

In some embodiments, the present invention is directed at a formulation of recycled reclaimed asphalt pavement comprising a fractionated recycled asphalt product; a rejuvenating emulsion comprising a stable liquid dispersion in water of at least one rejuvenating agent and a first surfactant; and an asphalt emulsion comprising a stable liquid dispersion in water containing an asphalt portion and a second surfactant.

In some embodiments, the present invention is directed at a rejuvenated asphalt pavement comprising a fractionated recycled asphalt product, a rejuvenating emulsion, and an asphalt emulsion atop a surface, the rejuvenating emulsion comprising a stable liquid dispersion in water of at least one rejuvenating agent and a first surfactant, and the asphalt emulsion comprising a stable liquid dispersion in water containing an asphalt portion and a second surfactant.

In some embodiments, the rejuvenating emulsion is mixed with the reclaimed asphalt pavement before being mixed with the asphalt emulsion.

In some embodiments, the rejuvenating emulsion is mixed with the asphalt emulsion before being mixed with the fractionated recycled asphalt product.

In some embodiments, the first surfactant in the rejuvenating emulsion has a faster setting time than the second surfactant in the asphalt emulsion.

In some embodiments, a mixture of the rejuvenating emulsion and the asphalt emulsion have a first dispersion containing the rejuvenating agent and a second dispersion containing the asphalt portion.

In some embodiments, the rejuvenating emulsion does not contain any virgin asphalt.

In some embodiments, a mixture of the rejuvenating emulsion and the asphalt emulsion comprises less than about 5% by weight of the fractionated recycled asphalt product, in some embodiments less than about 4% by weight of the fractionated recycled asphalt product, and in some embodiments less than about 3% by weight of the fractionated recycled asphalt product.

In some embodiments, the fractionated recycled asphalt product comprises reclaimed asphalt pavement, in some embodiments recycled asphalt shingles, in some embodiments a mixture of reclaimed asphalt pavement and recycled asphalt shingles, and in some embodiments reclaimed asphalt pavement from a deteriorated asphalt surface.

In some embodiments, the fractionated recycled asphalt product passes through a 2 inch sieve, more preferably a 1¼ inch sieve.

In some embodiments, the fractionated recycled asphalt product has a size less than about 1 inch.

In some embodiments, at least 95% of the fractionated recycled asphalt product has a size less than about ¾ inch. In some embodiments, at least 70% of the fractionated recycled asphalt product has a size less than about ½ inch. In some embodiments, at least 60% of the fractionated recycled asphalt product has a size less than about ⅜ inch.

In some embodiments, the rejuvenating emulsion contains the rejuvenating agent to the water in a ratio of about 0.25:1 to about 3:1.

In some embodiments, the rejuvenating agent is about 25% to about 75% of the total weight of the rejuvenating emulsion.

In some embodiments, the asphalt emulsion contains the asphalt portion to the water in a ratio of about 1:1 to about 3:1.

In some embodiments, the asphalt portion is about 40% to about 80% of the total weight of the asphalt emulsion.

In some embodiments, the rejuvenating emulsion comprises less than about 2% by weight of the fractionated recycled asphalt product. In some embodiments, the rejuvenating emulsion comprises less than about 1% by weight of the fractionated recycled asphalt product. In some embodiments, the rejuvenating emulsion comprises less than about 0.5% by weight of the fractionated recycled asphalt product.

In some embodiments, the surface is a deteriorated asphalt pavement.

In some embodiments, the rejuvenating emulsion comprises a biobased rejuvenating oil, an aromatic rejuvenating oil, a naphthenic rejuvenating oil, a paraffinic rejuvenating oil, or a mixture thereof.

In some embodiments, the rejuvenating agent comprises biobased oils or esters thereof.

In some embodiments, the rejuvenating agent comprises one or more of a vegetable oil or ester thereof, a seed oil or ester thereof, a soybean oil or ester thereof, a corn oil or ester thereof, a palm oil or ester thereof, a canola oil or ester thereof, a safflower oil or ester thereof, a sunflower oil or ester thereof, a citrus oil or ester thereof, pine oil or ester thereof, a rosin oil or ester thereof, a biobased fatty acid ester, or a combination thereof.

In some embodiments, the asphalt emulsion comprises one or more polymers. In some embodiments, the asphalt emulsion comprises an acrylic polymer. In some embodiments, the asphalt emulsion comprises an elastomer or plastomer. In some embodiments, the asphalt emulsion comprises one or more styrene-butadiene, styrene-butadiene-styrene or polychloroprene rubber.

In some embodiments, the first surfactant in the rejuvenating emulsion comprises a cationic surfactant, an anionic surfactant, amphoteric surfactant or non-ionic surfactant.

In some embodiments, the second surfactant in the asphalt emulsion comprises a cationic surfactant, an anionic surfactant, an amphoteric surfactant or non-ionic surfactant.

In some embodiments, the rejuvenation formulation is applied as a scrub seal, fog seal, sand seal, chip seal, tack coat, bond coat, crack filler or as a material for prevention of reflective cracking.

In some embodiments, the rejuvenating emulsion breaks before the asphalt emulsion.

Although specific embodiments have been illustrated and described herein for purposes of description of the preferred embodiments, it will be appreciated by those of ordinary skill in the art that a wide variety of alternate or equivalent implementations calculated to achieve the same purposes may be substituted for the specific embodiments shown and described without departing from the scope of the present invention. This application is intended to cover any adaptations or variations of the preferred embodiments discussed herein. Therefore, it is manifestly intended that this invention be limited only by the claims and the equivalents thereof.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A rejuvenation formulation comprising:
a rejuvenating emulsion comprising a stable liquid dispersion in water of at least one rejuvenating agent and a first surfactant; and
an asphalt emulsion comprising a stable liquid dispersion in water containing an asphalt portion and a second surfactant.

2. The rejuvenation formulation of claim 1, further comprising a fractionated recycled asphalt product.

3. The rejuvenation formulation of claim 2, comprising less than about 5% by weight of the fractionated recycled asphalt product.

4. The rejuvenation formulation of claim 2, wherein the fractionated recycled asphalt product comprises reclaimed asphalt pavement, recycled asphalt shingles, or a mixture thereof.

5. The rejuvenation formulation of claim 2, wherein at least 95% of the fractionated recycled asphalt product has a size less than about ¾ inch.

6. The rejuvenation formulation of claim 1, wherein the first surfactant in the rejuvenating emulsion has a faster setting time than the second surfactant in the asphalt emulsion.

7. The rejuvenation formulation of claim 1, further comprising a first dispersion containing the rejuvenating agent and a second dispersion containing the asphalt portion.

8. The rejuvenation formulation of claim 1, wherein the rejuvenating emulsion does not contain any virgin asphalt.

9. The rejuvenation formulation of claim 1, wherein the rejuvenating emulsion contains the rejuvenating agent to the water in a ratio of about 0.25:1 to about 3:1.

10. The rejuvenation formulation of claim 1, wherein the rejuvenating agent is about 25% to about 75% of the total weight of the rejuvenating emulsion.

11. The rejuvenation formulation of claim 1, wherein the rejuvenating emulsion comprises a biobased rejuvenating oil, an aromatic rejuvenating oil, a naphthenic rejuvenating oil, a paraffinic rejuvenating oil, or a mixture thereof.

12. The rejuvenation formulation of claim 1, wherein the asphalt emulsion comprises one or more polymers.

13. A method for rejuvenating deteriorated asphalt, the method comprising:
mixing a rejuvenating emulsion and an asphalt emulsion to form a rejuvenation blend, the rejuvenating emulsion comprising a stable liquid dispersion in water of at least one rejuvenating agent and a first surfactant, and the asphalt emulsion comprising a stable liquid dispersion in water containing an asphalt portion and a second surfactant; and
applying the rejuvenation blend to a surface.

14. The method of claim 13, further comprising mixing a fractionated recycled asphalt product to form the rejuvenation blend.

15. The method of claim 14, wherein the rejuvenating emulsion is mixed with the fractionated recycled asphalt pavement before being mixed with the asphalt emulsion.

16. The method of claim 14, wherein the rejuvenating emulsion is mixed with the asphalt emulsion before being mixed with the fractionated recycled asphalt product.

17. The method of claim 13, further comprising mixing a fractionated recycled asphalt product to form the rejuvenation blend.

18. The method of claim 13, wherein the first surfactant in the rejuvenating emulsion has a faster setting time than the second surfactant in the asphalt emulsion.

19. The method of claim 13, wherein the rejuvenation blend comprises a first dispersion containing the rejuvenating agent and a second dispersion containing the asphalt portion.

20. The rejuvenation formulation of claim 1, wherein the rejuvenating emulsion comprises a biobased rejuvenating oil, an aromatic rejuvenating oil, a naphthenic rejuvenating oil, a paraffinic rejuvenating oil, or a mixture thereof.
